(19) United States
(12) Patent Application Publication
(10) Pub. No.: US 2017/0238502 A1
(43) Pub. Date: Aug. 24, 2017

(54) COLLAPSIBLE DOG BASKET

(71) Applicant: CAVA PLASTICS A/S, MARIAGER (DK)

(72) Inventor: NIELS PETER ESTRUP, HINNERUP (DK)

(21) Appl. No.: 15/046,670

(22) Filed: Feb. 18, 2016

(51) Int. Cl. A01K 1/035; B65D 21/08; B65D 25/30; A01K 1/02

(52) U.S. Cl. CPC A01K 1/0353; A01K 1/0254; B65D 21/086; B65D 25/30

(57) ABSTRACT

A collapsible dog basket is provided. The basket includes bottom and side walls made of plastic and flexible bendable joints around which the bottom and side walls are folded such that the dog basket has a collapsed position. The bendable joints are made of a flexible plastic material being more flexible than the remaining part of the dog basket. The sidewalls of the dog basket are directly connected with the bottom so that the collapsible dog basket is in one piece. When collapsing the basket, the bottom is pressed upwards between the side walls. The bottom has special air circulation holes to make sure that the dog gets the right air circulation while sleeping in the basket. The holes also prevent the body heat from the dog from getting in contact with the floor surface underneath the dog basket.

### FIELD OF TECHNOLOGY

The following relates to a collapsible dog basket comprising bottom and side walls made of plastic, wherein the dog basket comprises at least one flexible bendable joint around which flexible bendable joint at least a part of said bottom and/or side walls are folded such that said dog basket has a collapsed position, wherein at least a part of said bendable joint is made of a flexible plastic material being more flexible than the remaining part of said dog basket.

### BACKGROUND

A dog basket typically takes up a lot of space in the house/apartment, guesthouse and summerhouse, and especially when traveling. Either the basket is made of wood or plastic or like a big pillow, all types take up a lot of space because they cannot be folded and stowed away.

All pet dogs have their own sleeping area in people's houses/apartments. This basket is the dog's domain and the dog needs this area during the day and nighttime. The basket will deliver the necessary feeling of safety for the dog.

A dog bed comprising a first resting place for a dog which resting place is arranged in a housing comprising a bottom plate and having walls and being closed on all sides with the exception of a section comprising an entrance for the dog.

In U.S. Pat. No. 5,497,729 a dog bed is known which is collapsible. The sidewalls and the bottom are separately collapsible. Accordingly the dog bed will have side wall which may be collapsed after the bottom is removed from the sidewalls and the bottom may also be collapsed after being removed from the sidewalls. This dog bed is difficult to fold and furthermore it is difficult for the dog to get the right air as the bottom is a closed plastic panel.

### SUMMARY

An aspect relates to a collapsible dog basket which overcome the drawbacks of the prior art dog bed.

According to embodiments of the present invention, this is obtained with a collapsible dog basket mentioned by way of introduction and which is peculiar in that the sidewalls of said dog basket are directly connected with the bottom so that the collapsible dog basket is in one piece and when collapsing said basket, said bottom is pressed upwards between said side walls and that the bottom has special air circulation holes to make sure that the dog gets the right air circulation while sleeping in the basket, and the holes also prevent the body heat from the dog from getting in contact with the floor surface underneath the dog basket.

This dog basket is made of plastic and it is foldable. This gives the family the opportunity to easily bring the dog's bed, when moving around in the house or when traveling, visiting someone. Now you can bring the dog's own sleeping domain no matter where you go.

This basket is very easy to clean as it is all made of plastic and can go straight into the shower for a wash. The basket folds down and the mattress is foldable too. The two component plastic mold makes it very easy to fold down. The folding lines are made of a soft plastic material. This material gives the basket a non-slip function when it is in use.

The basket has a bottom place which will fold up inside the sides. This bottom place will have some holes to secure some air circulation into the basket, when the dog is sleeping.

The mattress is also made in air circulated material.

This dog basket is a basket that will give the dog all the normal comfort, but the possibility to fold the basket and bring it with you this easy way is new.

A fold-up plastic dog basket for big dogs is normally made of linen or metal, here we do it easily in two component plastic which is light, easy to clean and good for recycling and for small and bigger dogs.

The basket has air circulation holes in the bottom of the bottom plate. This allows the body heat from the dog to get out from the basket without damaging the carpet/surface. The air circulation holes also bring the temperature inside the basket to a more constant level.

The basket easily fits into a car or you can transport it on a bike if you are travelling. The basket comes with a small bag to fold it into.

Various embodiments of the invention provide a collapsible dog basket which solves the above-mentioned problems.

In one aspect this is achieved by a collapsible dog basket comprising bottom and side walls made of plastic, wherein the dog basket comprises at least one flexible bendable joint around which flexible bendable joint at least a part of said bottom and/or side walls are folded such that said dog basket has a collapsed position wherein at least a part of said bendable joint is made of a flexible plastic material being more flexible than the remaining part of said dog basket and wherein the side walls of said dog basket are directly connected and when collapsing said dog basket, said bottom is pressed upwards between said side walls.

The bendable joint is constructed of a more flexible plastic material than the remaining part of the dog basket, thus improving the stability of the dog basket's side walls and bottom, and the bendable joint can therefore be designed to have the same dimensions as the remaining part of the dog basket and thus be more resistant to wear and tear. The aesthetic look of the dog basket is also improved as the dog basket looks like a regular dog basket.

The dog basket is curved on one side. This will allow easy entrance for the dog.

The bottom is also made with thin (5mm) air circulation holes. This prevents the heat from the dog's body to harm the floor surface/carpet.

The holes also give the dog air circulation inside the basket while resting.

It is further achieved that the volume and/or surface area of the collapsible dog basket is reduced when having a collapsed position and the collapsible dog basket may be collapsed and unfolded many times without tearing it. This entails that the dog basket takes up less space and thus is easier to store and transport. It is hereby advantageously achieved that the dog basket with flexible bendable joints could be constructed of plastic such as polypropylene co-polymers and thermoplastic elastomers, where the bendable joints are made of thermoplastic elastomers, and where the bottom and side walls are made of polypropylene co-polymers.

The bottom, side walls and bendable joints could then be integrated with each other, thereby ensuring that the dog basket remains strong and tight. In addition a simple, easy and quick production of the dog basket is ensured in that standardized molding processes may be used.

According to a further embodiment the collapsible dog basket is peculiar in that at least a part of said flexible plastic material of said bendable joint is integrated with at least a part of said bottom and/or side walls.

According to a further embodiment the collapsible dog basket is peculiar in that at least one of said bendable joints comprises at least one extended portion, where the extent of said bendable joint has been increased relative to at least another part of said bendable joint.

According to a further embodiment the collapsible dog basket is peculiar in that at least one of said side walls comprises at least one strengthened portion.

According to a further embodiment the collapsible dog basket is peculiar in that said at least one strengthened portion comprises a curved portion bending relative to said side wall and an edge portion being substantially parallel to said side wall.

According to a further embodiment the collapsible dog basket is peculiar in that at least a part of said bendable joint is made of thermoplastic elastomer.

According to a further embodiment the collapsible dog basket is peculiar in that at least a part of said bottom and/or side wall is made of polypropylene, co-polymer and thermoplastic elastomers.

According to a further embodiment the collapsible dog basket is peculiar in that the basket further comprises means for locking the dog basket together into a thin position, when moving it.

According to a further embodiment the collapsible dog basket is peculiar in that it will have a lower entrance side to make it easier to enter.

According to a further embodiment the collapsible dog basket is peculiar in that it has two hole handles for easily moving the whole basket, the two holes fit two human hands for getting a firm grip, when lifting the dog basket.

According to a further embodiment the collapsible dog basket is peculiar in that at least one of said bendable joints is positioned such that said bottom and said side walls in said collapsed position are substantially parallel.

According to a further embodiment the collapsible dog basket is peculiar in that at least one of said bendable joints is positioned such that at least a part of said bottom is positioned between at least two of said side walls in said collapsed position.

According to a further embodiment the collapsible dog basket is peculiar in that the basket has a mattress that is made of a soft material and it is foldable in the middle, which mattress will go inside the folded dog basket and stay there when transporting the dog basket.

According to a further embodiment the collapsible dog basket is peculiar in that the basket has a lower side wall in one side, which gives the dog a nice lower step for entrance into the basket.

### BRIEF DESCRIPTION

Some of the embodiments will be described in detail, with reference to the following figures, wherein like designations denote like members, wherein:

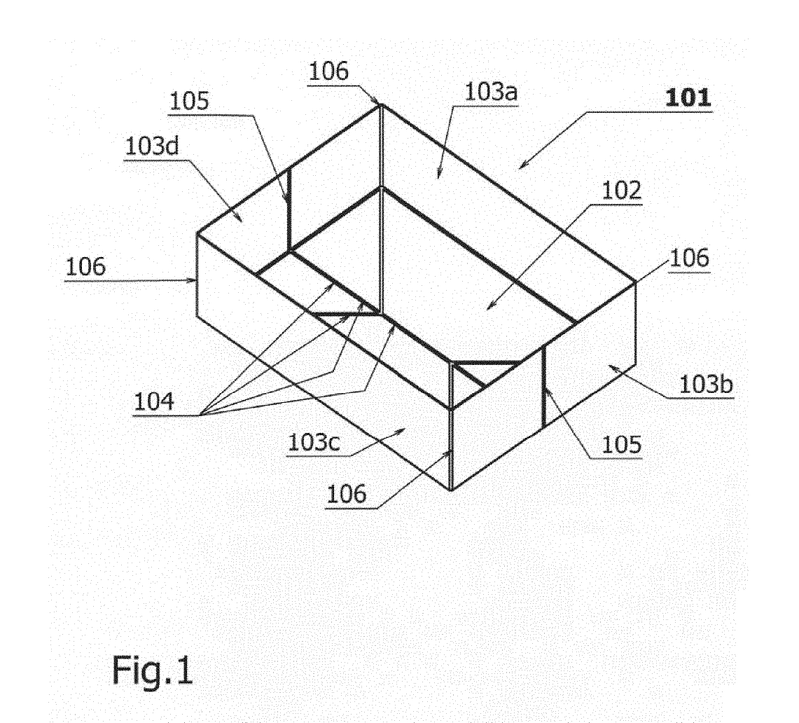

FIG. 1 illustrates a collapsible dog basket in accordance with a first embodiment of the invention in an unfolded position;

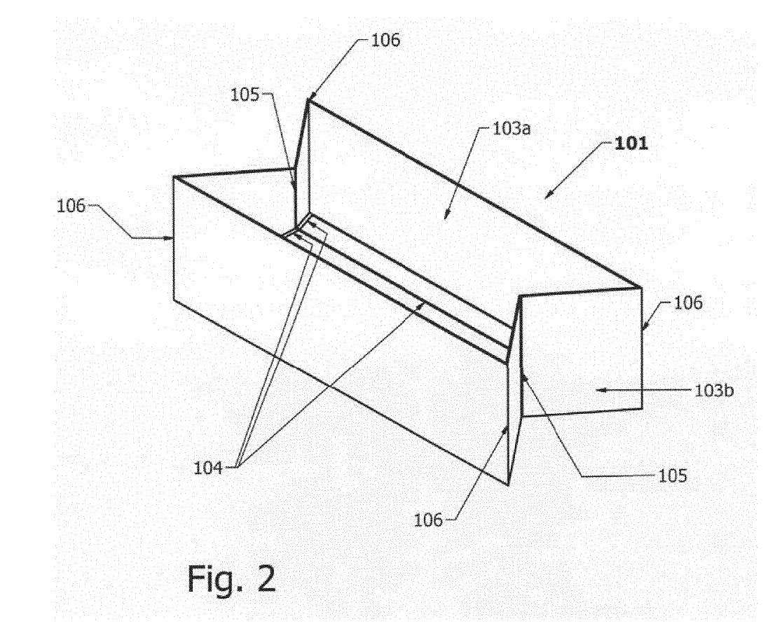

FIG. 2 illustrates the dog basket in a semi-collapsed position in accordance with said first embodiment of the invention;

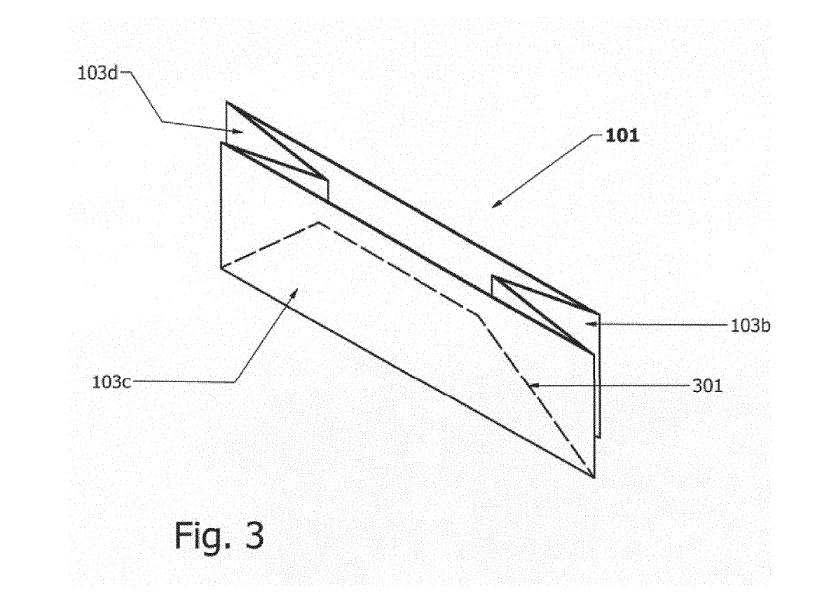

FIG. 3 illustrates a dog basket in a collapsed position in accordance with said first embodiment of the invention;

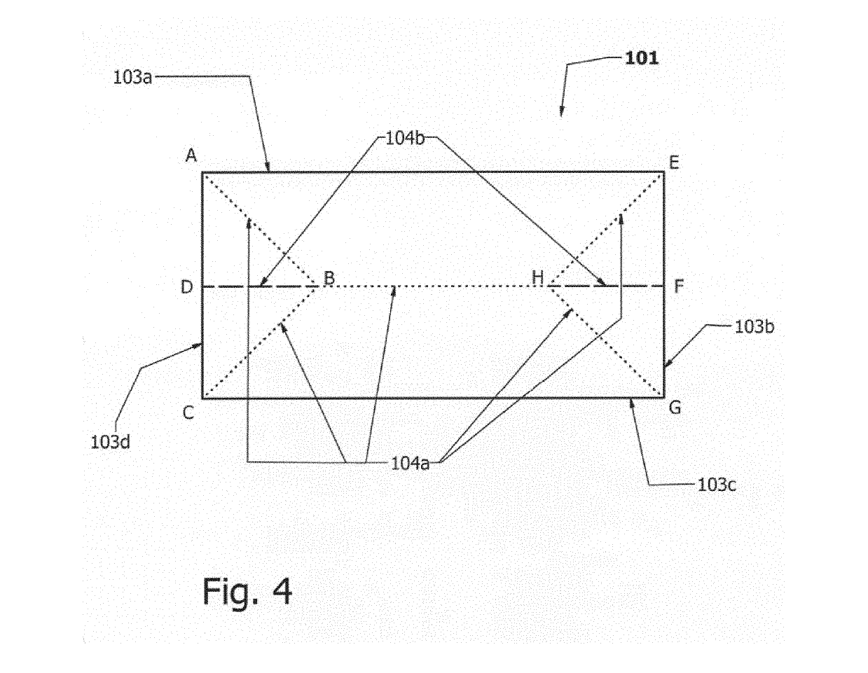

FIG. 4 illustrates the dog basket in an unfolded position and seen from above in accordance with said first embodiment of the invention;

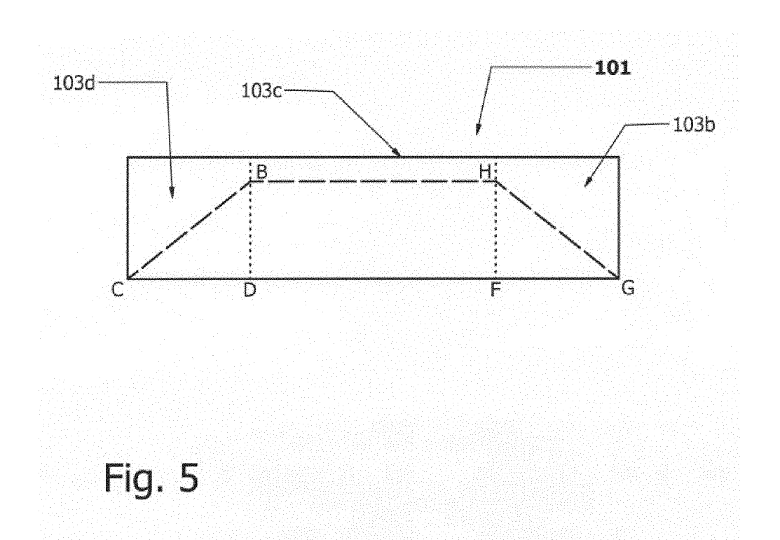

FIG. 5 illustrates a front view of the dog basket in a collapsible position in accordance with said first embodiment of the invention;

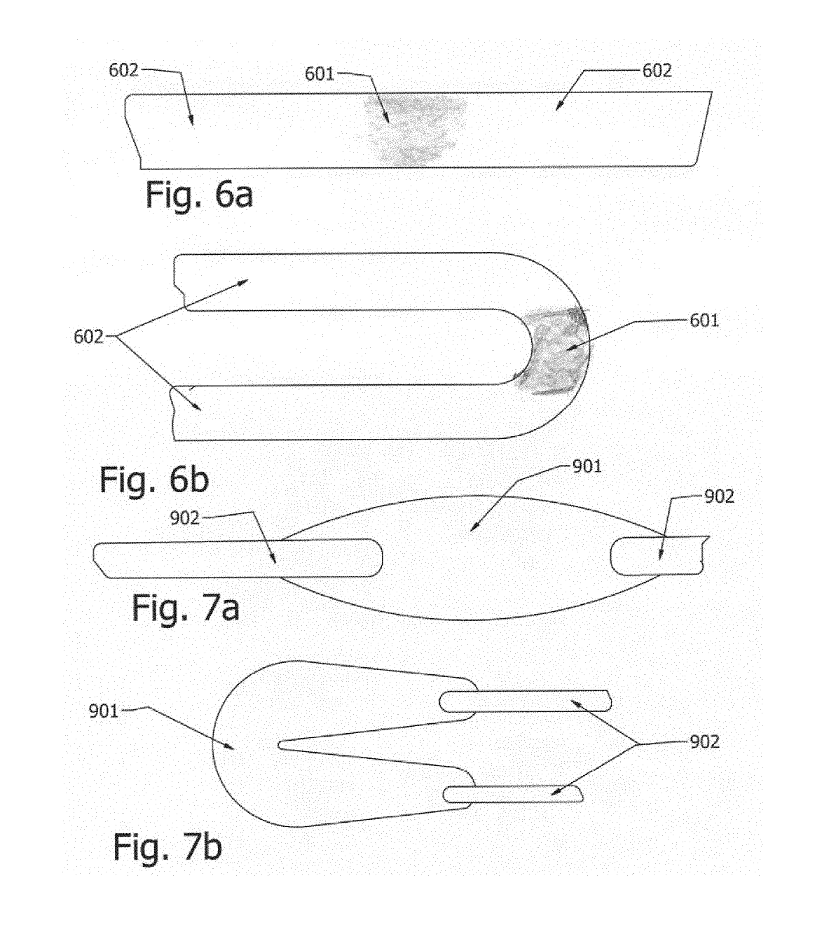

FIG. 6a illustrates an embodiment of a bendable joint;

FIG. 6b illustrates a different embodiment of a bendable joint;

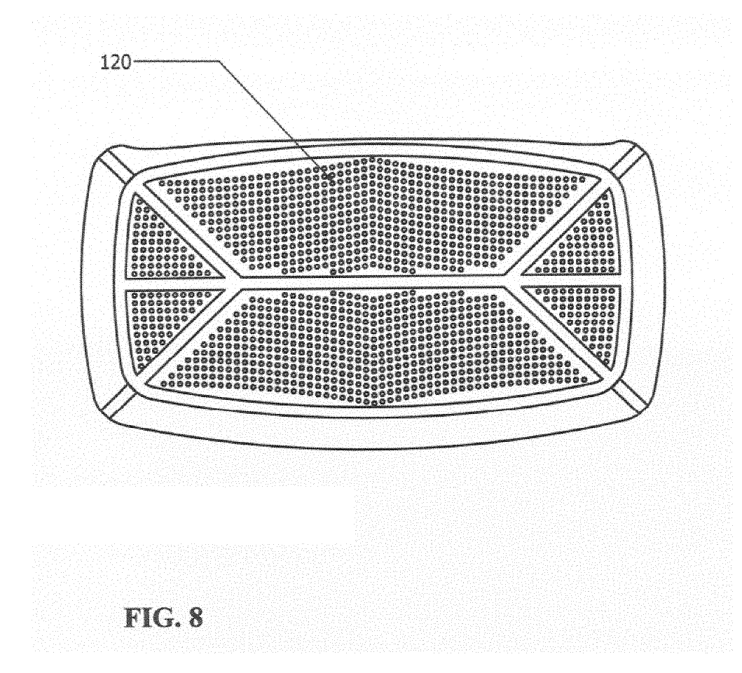

FIG. 7a illustrates a different embodiment of a bendable joint;

FIG. 7b illustrates a different embodiment of a bendable joint;

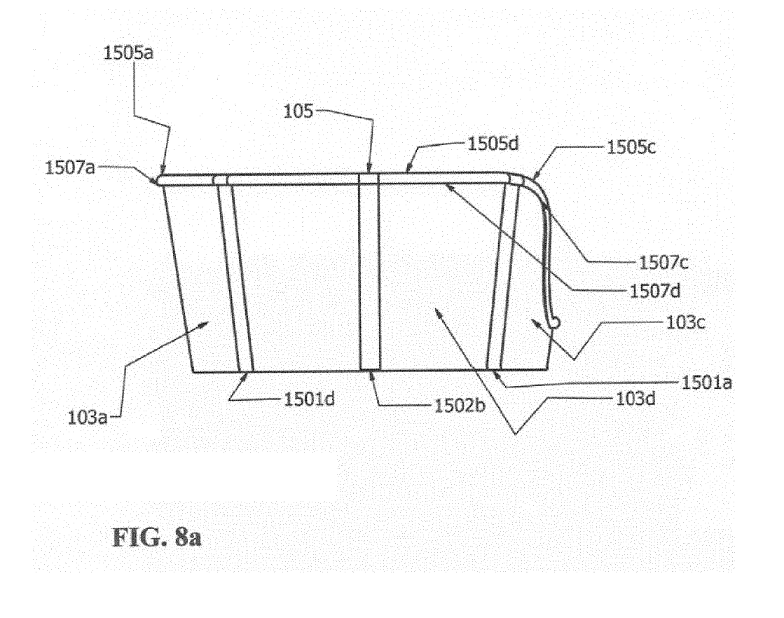

FIG. 8 illustrates a second embodiment of the collapsible dog basket in an unfolded position and shows all the air circulation holes;

FIG. 8a illustrates said second embodiment of the dog basket seen from the end-side-view position; and

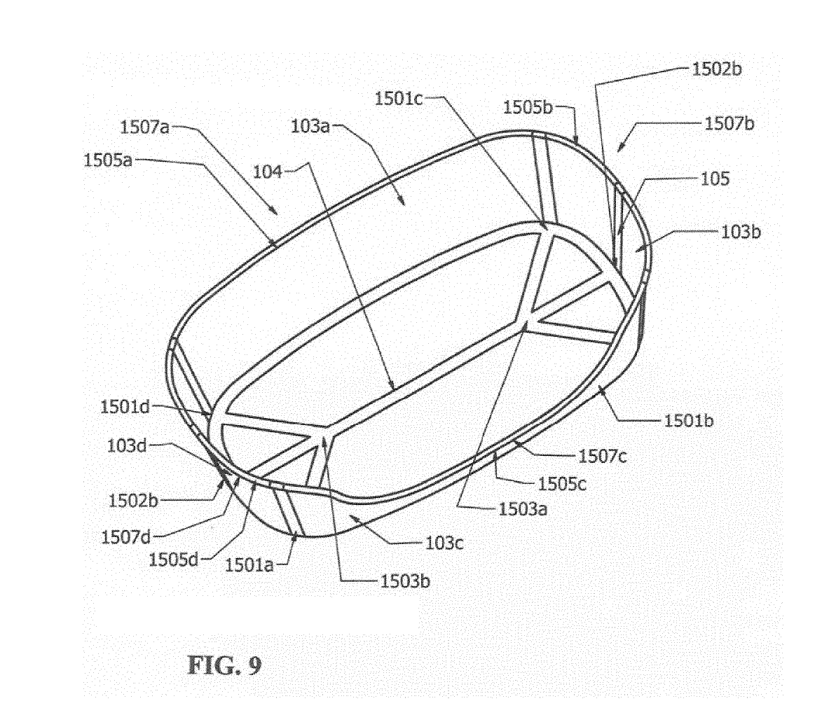

FIG. 9 illustrates the dog basket in accordance with said second embodiment and with all the folding lines and the lower entrance curve.

### DETAILED DESCRIPTION

FIG. 1 shows a collapsible dog basket (101) according to one embodiment of the invention in an unfolded position. The dog basket comprises a bottom (102) and four side walls (103a, 103b, 103c, 103d). The dog basket further comprises flexible bottom bendable joints (104) around which a part of the bottom is folded and flexible side bendable joints (105) around which some of the side walls are folded, and in addition the edges of the dog basket are constructed as flexible edge bendable joints (106) around which two different side walls may be folded.

FIG. 2 shows the collapsible dog basket in a semi-collapsed position and illustrates that the bottom (102) is folded around the flexible bottom bendable joints (104) such that a part of the bottom is lifted between the side walls (103a and 103c) simultaneously with the side walls (103b) and (103d) being folded around the flexible bendable joints (105) provided in said side walls, and simultaneously with the flexible edge bendable joints being folded (106) such that the side walls (103b) and (103d) are folded in between the side walls (103a) and (103c).

FIG. 3 shows the dog basket in a collapsed position and illustrates how the side walls (103a) and (103c) and the bottom (102) are positioned in between the side walls (103b) and (103d) when the basket is in a collapsed position. The position of the bottom between the side walls (103a) and (103c) are illustrated by way of dotted lines (301). The result is that the dog basket takes up a lot less space when being collapsed than when being unfolded.

FIG. 4 illustrates the dog basket in an unfolded position and seen from above. The position of the flexible bottom bendable joints (104) is shown such that bottom bendable joints adapted for bending the bottom parts upwards (out of the page) are illustrated by dotted lines (104a), and bottom bendable joints adapted for bending the bottom parts downwards (into the page) are illustrated by dashed lines (104b). This position of the bottom bendable joints results in the fact that the triangles ABC and EGH may be folded up around bottom bendable joint BD and HF, respectively, when the bottom bendable joints AB, BC, BH, HE and HG are folded up. The result is that the bottom parts may be lifted to upright position such that trapezes ABHE and CBHG are positioned substantially parallel relative to one another in an upright position, while the triangles ABC and EGH are folded up and in between the outer part of the two trapezes.

The length of the bottom bendable joints DB and HF is in this embodiment adapted to equal half the width of the dog basket as this makes the side walls (103b), (103d) and the bottom foldable in between the side walls (103a) and (103c). If the length of the bendable joints DB and HF is longer than half the width of the basket, a part of the bottom will project from the side walls (103a) and (103c), while a part of the side walls (103b) and (103d) will project from the sides (103a) and (103c) if the bendable joints DB and HF are shorter than half the width of the basket.

FIG. 5 shows the basket in a collapsed position and seen from the side. The inner structures of the bottom are illustrated by way of dotted lines. The dotted lines illustrate that the side walls (103c) and (103b) are folded in between the two trapezes.

FIG. 6 illustrates an embodiment of a bendable joint and shows a cross-sectional view of the bendable joint in an unfolded (FIG. 6a) and bended position (FIG. 6b). The dog basket is in this embodiment molded in plastic, and the bendable joint is constructed by molding it in flexible plastic (601) which makes it possible to fold up the surrounding side walls (602) as shown in FIG. 6b. This is for instance achieved by adding softeners to the part of the plastic which is used to mold the bendable joints or by using more flexible plastic material for the flexible joints than for the remaining part of the flexible basket.

In another embodiment the basket is molded in polystyrene, and the bendable joints are constructed by foaming the plastic, which constitutes the bendable joints, to a greater extent than the plastic in the remaining part of the basket. It is hereby achieved that the plastic, which constitutes the bendable joints, is more flexible than the rest of the basket.

The bendable part could for instance be constructed by plastic materials such as Thermoplastic Elastomers (TPE) which is a family of polymers that can be repeatedly stretched without permanently deforming the shape of the part. Thermoplastic Elastomers (TPEs) may be processed by conventional thermoplastic techniques such as injection molding, extrusion and blow molding. The TPEs could for instance be chosen from the following groups: styrene block copolymers, polyolefin blends (TPOs), elastomeric alloys, thermoplastic polyurethanes (TPUs), thermoplastic co-polyesters and thermoplastic polyamides. The remaining part of the basket could for instance be made of a plastic material such as polypropylene co-polymers (PP-CO), i.e. a type of polypropylene in which the basic structure of the polymer chain has been modified by the incorporation of a different monomer molecule.

FIG. 6a+b illustrate that the dog basket is in this embodiment molded in plastic, and the bendable joint is constructed by molding it in flexible plastic (601) which makes it possible to fold up the surrounding side walls (602) as shown in FIG. 6b.

FIG. 8 illustrates that the air circulations holes at the bottom of the basket (120) makes sure that the temperature inside the basket stays right. The holes are 5 mm and they prevent the

dog's body heat from influencing the floor surface. FIG. 8a illustrates the flexi basket seen from the end side. (1502b+1501a+1501d) show the folding lines (TPE or other soft plastic material).

FIG. 7 illustrates another embodiment of a bendable joint and shows a cross-sectional view of the bendable joint in an unfolded position (FIG. 7a) and in a bended position (FIG. 7b). The bendable joint (901) is in this embodiment constructed by an oblong flexible material such as for instance silicone, rubber, flexible plastic or the like which is attached between two side walls (902).

FIGS. 8a and 9 illustrates that beads of soft plastic material (1505a, 1505b, 1505c, and 1505d) are provided along the upper edges (1507a 1507b, 1507c and 1507d) of the side walls. Furthermore FIG. 9 illustrates folding lines (1501b, 1501c, 1503a and 1503b)

The oblong flexible material is bendable and the side walls are thus folded up as shown in FIG. 7b. This type of bendable joints may for instance be constructed by gluing the two side walls together by flexible silicone or rubber.

1. A collapsible dog basket including bottom and side walls made of plastic, the dog basket comprising:
at least one flexible bendable joint around which flexible bendable joint at least a part of said bottom and/or side walls are folded such that said dog basket has a collapsed position, wherein at least a part of said at least one bendable joint is made of a flexible plastic material being more flexible than a remaining part of said dog basket,
wherein the sidewalls of said dog basket are directly connected with a bottom so that the collapsible dog basket is in one piece and when collapsing said dog basket, said bottom is pressed upwards between said side walls, and that the bottom has a plurality of air circulation holes to make sure that the dog gets the right air circulation while sleeping in the dog basket, and the plurality of air circulation holes also prevent a body heat from the dog from getting in contact with a floor surface underneath the dog basket.

2. The collapsible dog basket of claim 1, wherein at least a part of said flexible plastic material of said at least one bendable joint is integrated with at least a part of said bottom and/or side walls.

3. The collapsible dog basket of claim 1, wherein at least one of said at least one bendable joint comprises at least one extended portion, where the extent of said at least one bendable joint has been increased relative to at least another part of said at least one bendable joint.

4. The collapsible dog basket of claim 1, wherein at least one of said side walls comprises at least one strengthened portion.

5. The collapsible dog basket of claim 4, wherein said at least one strengthened portion comprises a curved portion bending relative to said side wall and an edge portion being substantially parallel to said side wall.

6. The collapsible dog basket of claim 1, wherein at least a part of said at least one bendable joint is made of thermoplastic elastomer.

7. The collapsible dog basket of claim 1, wherein at least a part of said bottom and/or side wall is made of polypropylene, co-polymer and thermoplastic elastomers.

8. The collapsible dog basket of claim 1, further comprising a means for locking the dog basket together into a thin position, when moving it.

9. The collapsible dog basket of claim 1, further comprising a lower entrance side to make it easier to enter.

10. The collapsible dog basket of claim 1, further comprising two hole handles for easily moving the whole basket, the two holes fit two human hands for getting a firm grip, when lifting the dog basket.

11. The collapsible dog basket of claim 1, wherein at least one of said at least one bendable joint is positioned such that said bottom and said side walls in said collapsed position are substantially parallel.

12. The collapsible dog basket of claim 1, wherein at least one of said at least one bendable joint is positioned such that at least a part of said bottom is positioned between at least two of said side walls in said collapsed position.

13. A collapsible dog basket of claim 1, further comprising a mattress that is made of a soft material and it is foldable in a middle, wherein the mattress goes inside the folded dog basket and remains inside the folded dog basket when transporting the dog basket.

14. The collapsible dog basket of claim 1, further comprising a lower side wall in one side, which gives the dog a lower step for entrance into the dog basket.
